(19) United States
(12) Patent Application Publication
(10) Pub. No.: US 2012/0293891 A1
(43) Pub. Date: Nov. 22, 2012

(54) BATTERY DISCONNECT DEVICE FLASHOVER PROTECTION

(76) Inventor: Yeshaianou Aharon LEVINAS, Key Largo, FL (US)

(21) Appl. No.: 13/112,110

(22) Filed: May 20, 2011

(51) Int. Cl. H01H 9/30

(52) U.S. Cl. 361/13

(57) ABSTRACT

A disconnect device for selectively disconnecting a battery from a load includes a primary mechanical contact defining primary current path between the battery and the load. The device further includes a controller generating open and close commands for operating said primary contact and an electronic switch also operated by the controller. The electronic switch provides a secondary current path to eliminate flashover that may damage the primary mechanical contact.

### RELATED APPLICATIONS

None.

### BACKGROUND OF THE INVENTION

A. Field of Invention

This invention pertains to a device which can be installed in a motor vehicle such as an automobile, a truck or a sports utility vehicle. More particularly, the subject invention pertains to a device which automatically disconnects the battery of motor vehicle or other apparatus using batteries such as generators, emergency power systems, solar panels, power generating devices using wind, etc., and selectively reconnects the same on demand. Preferably, the device includes a microprocessor and a solid state bypass switch activated during the disconnect process to prevent flashovers.

Description of the Prior Art

A critical part of many electronic industrial devices including automotive vehicles are their batteries which provide power for various primary and secondary systems. Normally an industrial or automotive battery can last for a relatively long time since its charge is refreshed continuously as the device is operated. However, in some instances, such as for example, human error or when a short occurs in the vehicle wiring, or a control switch malfunctions, a leakage current may flow when the engine is off, discharging the battery.

In order to protect an industrial battery from such an occurrence, protective devices have been proposed that can interrupt undesirable leakage current flow. However, these devices have several disadvantageous features. One such feature is that they interpose a relatively high series resistance between the battery and the car wiring. Therefore a high IR drop is developed, especially at high current drains, thereby reducing the voltage that is available to the vehicle systems, wasting energy, and generating undesirable heat. Moreover, this heat reduces the useful life of the disconnect device and cause it to fail prematurely. Of course, if the device fails in the open position, the industrial device or motor vehicle is effectively disabled and a mechanic unfamiliar with the protective device will not be able to trance the problem to the faulty and possibly burned out disconnect device.

A further disadvantage of the proposed devices is that they may not stand up to the extremely hostile environment(for example, the environment existing under the hood of motor vehicles.) These environments are characterized by high temperatures as well as corrosive fumes which damage sensitive electronic circuitry.

Another problem associated with standard disconnect switches is that they are prone to damage by sparks and flashovers. More specifically, when a switch is closed, a high-energy flash may occur. The intensity and energy content of the flash depend on the load on the battery at the moment the switch is operated, and, especially, for a switch opening, the inductive load. If the flashover or spark has a very high energy content, it may cause some of the material of the switch contacts to be evaporated, thereby reducing the surface area of the contacts and increasing the series resistance of the switch. In fact, in some instances, the flash or spark may be so strong that it may cause the contact material to melt temporarily and then resolidify to form a bridge over the gap between the contacts, and/or form a weld between the contacts. In either case, the disconnect switch becomes disabled.

U.S. Pat. No. 6,424,511 provides a battery disconnect switch that resolves some of the problems mentioned above. However, it does not address other problems related to extreme temperatures (hot or cold), high current drains during the normal operation of the vehicle, flashovers, etc.

### SUMMARY OF THE INVENTION

Briefly, a protective device for an industrial device includes a control circuit that sense several preselected conditions; connecting elements such as bars connecting said battery to the vehicular equipment; and an electromagnetic switch such as a solenoid having a coil and a contact selectively connecting the bars. The coil is activated when an abnormal condition is sensed by the control circuit. These conditions may include a current drain on the battery. A manual push button may be used to control the protective device.

Additional elements are used to provide other advantageous features. One such element is a remote trip or close circuit which allows the coil to be tripped or closed remotely thereby allowing the device to be used as an antitheft device. The remote close circuit and/or the remote trip circuit could be activated by a switch or a portable rf transmitter. Importantly, a secondary electronic switch is also provided that is closed before the primary electromagnetic switch and opens after the electromagnetic switch. This operation prevents flashovers that can damage the contact of the electromagnetic switch.

### BRIEF DESCRIPTION OF THE DRAWINGS

FIG. 1 shows a typical wiring diagram showing a battery feeding buses for one or more loads through a disconnect switch constructed in accordance with this invention; and

FIG. 2 shows a somewhat diagrammatic block diagram of the disconnect switch of FIG. 1.

### DETAILED DESCRIPTION OF THE INVENTION

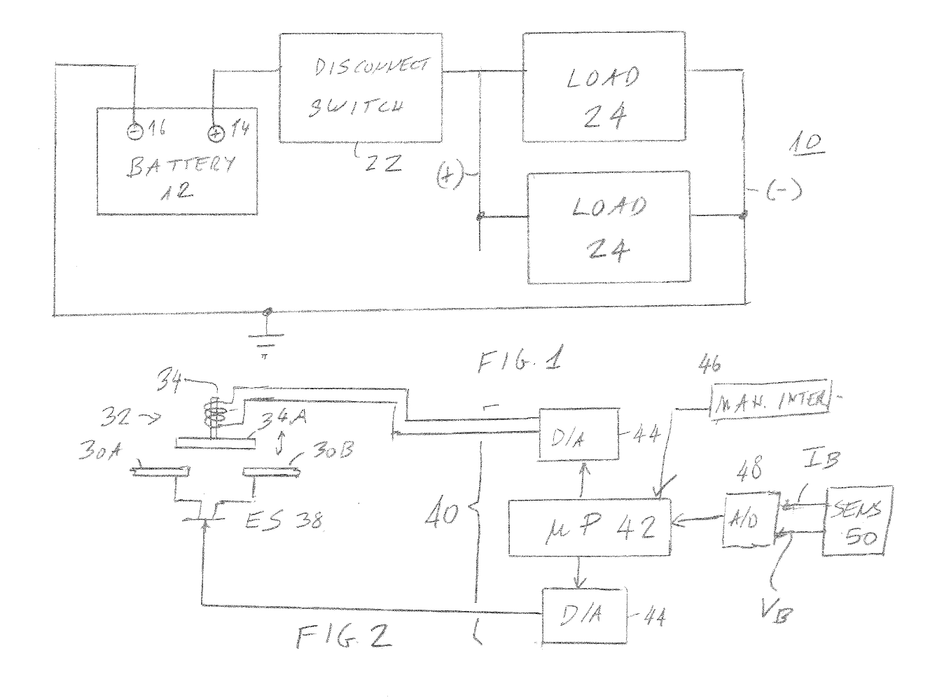

By way of introduction, FIG. 1 shows a typical block diagram of an equipment with a disconnect switch constructed in accordance with this invention for controlling power to one or more industrial devices from a battery. In this figure, a system 10 includes a battery 12 with a positive terminal 14 and a negative terminal 16. The negative terminal 16 is connected to a ground bus 18 that constitutes the common ground for the system. (It should be understood that in some systems, a common positive bus may be used instead of a common negative as the ground.)

The positive terminal 14 is selectively connected to a positive bus 20 by disconnect device 22. It should be understood that in this description, the positive and negative buses 20, 18 are just illustrative examples of how one or more loads 24 could be powered, it being understood that other means of providing power may be used, such as, for example, individual point-to-point wires or cables.

As discussed in more details below, the disconnect switch 22 is selectively opened and closed to control the power provided by battery 12 to one or more loads 24. For example, in a motor vehicle, the loads may represent various accessories such as lights, an entertainment system, a fuel injector, etc. Other industrial devices may be provided with DC from a similar battery by the switch 22. Once switch 22 is closed, when some predetermined conditions occur, the disconnect switch opens thereby cutting the power to loads 24.

Referring now to FIG. 2, the disconnect switch 22 includes an input bar 30A connected to the positive terminal 14, either directly or via an appropriate cable. A second bar 30B is connected to bus 20. An electromagnetic device such as a solenoid 32 having a plunger 34 terminating in a solenoid contact 34A and a coil 36 is used to provide selectively a high current electrical path between bars 30A, 30B. It should be understood that the solenoid may have other elements, such as biasing springs, etc., which have been omitted for the sake of clarity.

An electronic switch 38, such as MOSFET transistor or similar element provides a secondary current path between the bars 30A, 30B.

The switch 22 further includes a controller 40 that controls the operation of the solenoid 32 and the switch 38. The controller 40 includes a microprocessor 42, D/A interfaces 44 and at least a manual interface 46 that receives commands from a user or from another device, such as an RF fob (not shown) to operate the device 22. In addition, or optionally, the device further includes an A/D interface 48 and one or more sensors 50. The sensors measure various parameters associated with the loads 24, and/or battery 12, such as the voltage Vb of the battery, the current lb supplied by the battery, etc. These parameters are translated into digital signals, if necessary, and then provided to the microprocessor 42. The microprocessor makes use of these signals and some predetermined rules to decide whether to open or close the disconnect device 12.

The disconnect device operates as follows. Initially the device is open. In response to a command from a user, or because some predetermined conditions have occurred, as indicated by the sensor signals from the sensor, the controller 40 starts the closing sequence. For this sequence, the microprocessor first sends a signal to the electronic switch 38 causing it to close, thereby creating a secondary path between the bars 30A, 30B. A very short period later, in the order of 1-5 microseconds, the microprocessor 42 sends a separate signal energizing the coil 36 and causing the plunger 34 to move toward and contact the bars 30A, 30B. Once a solid contact is made between the plunger 34 and bars 30A, 30B, a high current, low resistance path is established between bars 30A, 30B. Since the bars are already at the same potential prior to the closing of the solenoid 32, no arching or flashover will occur. Once the solenoid is closed, or after a predetermined time period, the microprocessor sends a signal to open electronic switch 38 since it is no longer needed. Due to the internal resistance of the electronic switch 38, it will not overheat for the short period that it is on.

When the device has to open, the microprocessor first closes the electronic switch 38. A short time period later a control signal is sent to the solenoid 32 to open. As the solenoid opens, there is still a secondary current path between bars 30A, 30B through the switch 38 and therefore, again, arcing, or flashovers are prevented. After the solenoid 32 opens, the switch 38 is opened as well.

In an alternate embodiment, if the solenoid 32 may have an inherent delay either closing or opening so that the control signal to close or open it may be sent at the same time as the signal for the electronic switch. The electronic switch will close or open first since the solenoid needs more time to operate.

Numerous modifications may be made to this invention without departing from its scope as defined in the appended claims.

I claim:

1. A battery disconnect device for an industrial load from a a battery comprising:
a controller receiving signals and generating a command for selectively providing energy to the industrial load from the battery, the command including an open and a close command;
an electromagnetic switch providing a primary current path between the battery and the load, said electromagnetic switch opening and closing in response to said open and close commands; and
an electronic switch providing a secondary current path to prevent flashovers when said electromagnetic switch is operated.

2. The device of claim 1 wherein said electronic switch is opened after said electromagnetic switch.

3. The device of claim 1 wherein said electronic switch is closed before said electromagnetic switch.

4. The device of claim 1 wherein said electronic switch receives and is responsive to commands from said controller.

5. The device of claim 1 further comprising a user interface receiving user inputs, said controller being coupled to said user interface and operating in accordance with said user input.

6. The device of claim 1 further comprising a sensor detecting sensor signals related to one of said battery and said load and generating sensor inputs to said controller, wherein said controller generates said commands in response to said sensor inputs.
